(19) United States
(12) Patent Application Publication
(10) Pub. No.: US 2008/0178303 A1
(43) Pub. Date: Jul. 24, 2008

(54) INFORMATION-PROCESSING APPARATUS, INFORMATION-PROCESSING SYSTEM, INFORMATION-PROCESSING METHOD, COMPUTER-READABLE MEDIUM, AND COMPUTER DATA SIGNAL

(75) Inventor: Masao Nukaga, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/839,715

(22) Filed: Aug. 16, 2007

(30) Foreign Application Priority Data
Jan. 19, 2007 (JP) 200710495

(51) Int. Cl. G06F 7/04

(52) U.S. Cl. 726/33

(57) ABSTRACT

A second information-processing apparatus includes a registration unit that receives log information including information concerning an operator that performed an operation with respect to a first document, time and date of the operation, and a second document obtained as a result of the operation, from a first information-processing apparatus and registers the log information in a storage unit, the registration unit, when the first document is already registered in the storage unit, further registering in the storage unit a derivation relationship indicating that the first document is a parent of the second document; and a document-providing unit that, in response to a collection instruction including information that specifies a subject document, specifies and provides a latest version document with regard to each operator from documents included in a tree to which the subject document belongs among trees formed by derivation relationships stored in the storage unit.

### CROSS-REFERENCE TO RELATED APPLICATIONS

This application is based on and claims priority under 35 USC 119 from Japanese Patent Application No. 2007-10495, filed on Jan. 19, 2007.

### BACKGROUND

1. Technical Field

The present invention relates to an information-processing apparatus, an information-processing system, an information-processing method, a computer-readable medium, and a computer data signal.

2. Related Art

There has been a technology for registering an electronic document such as text document data, audio data, multimedia data, and so on (hereinafter also referred to simply as a “document”) in a server and providing the document in response to a user request. Also, there has been known a system in which a unique identifier is assigned to an electronic document and an electronic document corresponding to the identifier input by a user is provided. In another known system, during printing of an electronic document onto a paper sheet, an identifier of the electronic document is encoded and embedded into the paper document, such that, when the paper document is copied, the identifier embedded therein is recognized, the electronic document corresponding to the identifier is obtained, and then the electronic document information is used to print the paper document.

### SUMMARY

According to an aspect of the invention, there is provided a second information processing apparatus including a registration unit that receives log information including information concerning an operator that performed an operation with respect to a first document, time and date of the operation, and a second document obtained as a result of the operation, from a first information processing apparatus, and registers the log information in a storage unit, the registration unit, when the first document is already registered in the storage unit, further registering in the storage unit a derivation relationship indicating that the first document is a parent of the second document; and a document-providing unit that, in response to a collection instruction including information that specifies a subject document, specifies and provides a latest version document with regard to each operator from documents included in a tree to which the subject document belongs among trees formed by derivation relationships stored in the storage unit, on the basis of the log information.

### BRIEF DESCRIPTION OF THE DRAWINGS

Exemplary embodiments of the present invention will be described in detail by reference to the following figures, wherein:

FIG. 1 a block diagram schematically showing an example structure of a document use management system;

FIG. 2 is a block diagram showing an example internal structure of a client terminal;

FIG. 3 is a view schematically showing an example data structure of an ID-added document;

FIG. 4 is a block diagram showing an example internal structure of a document management server;

FIG. 5 is a view showing example data content of a derivation relationship DB;

FIG. 6 is a schematic view showing a tree structure formed by management IDs in the data content shown in FIG. 5;

FIG. 7 is a view showing an example display screen displaying icons of an ID-added document;

FIG. 8 is a flowchart showing a portion of an example processing procedure performed by a request-processing unit in response to a filled-in form collection request;

FIG. 9 is a flowchart showing the remaining portion of the example processing procedure performed by the request-processing unit in response to a filled-in form collection request;

FIG. 10 is a view showing an example display screen displaying a filled-in form search result;

FIG. 11 is a view showing example data content of a derivation relationship DB after the filled-in form has been obtained;

FIG. 12 is a view showing example data content of the derivation relationship DB after the filled-in form has been obtained;

FIG. 13 is a schematic view showing a tree structure formed by management IDs when an original form has been modified;

FIG. 14 is a view showing example data content of the derivation relationship DB corresponding to the tree structure shown in FIG. 13;

FIG. 15 is a flowchart showing a portion of an example processing procedure performed by a request-processing unit in response to a latest version form acquisition request;

FIG. 16 is a flowchart showing the remaining portion of the example processing procedure performed by the request-processing unit in response to a latest version form acquisition request;

FIG. 17 is an example display screen displaying a latest version form search result; and

FIG. 18 is a view showing an example hardware structure of a computer.

### DETAILED DESCRIPTION

An exemplary embodiment of the present invention will be described in detail with reference to the accompanying drawings.

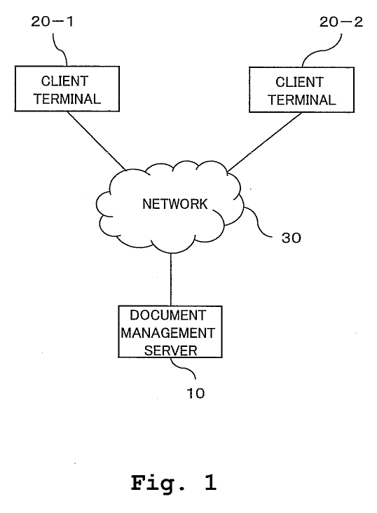

FIG. 1 is a block diagram schematically showing a structure of a document use management system. This system is formed of a document management server 10 and client terminals 20-1, 20-2, . . . (hereinafter collectively referred to a client terminal 20) that are connected to each other via a network 30 such as the Internet, a local area network (LAN), or the like.

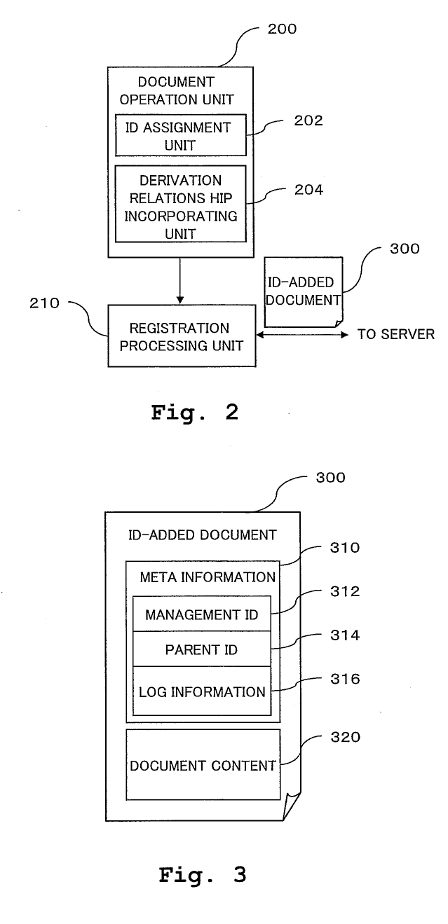

The client terminal 20 will be described with reference to FIG. 2. The client terminal 20 is a terminal used by a user for performing operations on a document, and may be a personal computer, a digital multifunction device, or the like. As shown in FIG. 2, the client terminal 20 includes a document operation unit 200 and a registration processing unit 210.

The document operation unit 200 is used for performing an operation with respect to a document, including displaying (i.e. “viewing” by a user), editing, printing and output of a document, reading and copying of a paper document, and so on. While only a single document operation unit 200 is shown in FIG. 2, the individual operations may be performed by different operation units (e.g. different applications such as an editing application and a reading control application). If the document operation unit 200 is software used for creating and editing an electronic document, such as a word processor, for example, the document operation unit 200, in accordance with a user's instruction, displays an electronic document or edits the electronic document. When performing an operation with respect to a document, the document operation unit 200 outputs an ID-added document 300 that represents a result of the operation.

As shown in FIG. 3, the ID-added document 300 is an electronic document including meta information 310 and a document content 320. The document content 320 corresponds to content data of a document that are generated as a result of the operation performed by the document operation unit 200. If the document operation unit 200 is software that creates and edits an electronic document, the document content 320 is a document file generated as a result of editing performed by the software. Alternatively, if the document operation unit 200 is a device that prints an electronic document, the document content 320 may be content data of an electronic document to be printed. Further, if the document operation unit 200 is a device that scans a paper document or a device that copies a paper document, the document content 320 may be image data obtained by reading the paper document.

The meta information 310 is information used for document management, and includes a management ID 312, a parent ID 314, and log information 316.

The management ID 312 is unique identification information of an ID-added document 300 itself. The parent ID 314 is a management ID of a parent ID-added document of that ID-added document 300. Specifically, in this exemplary embodiment, a certain ID-added document and a new ID-added document obtained by performing an operation with respect to the certain ID-added document are treated as being in a parent-child relationship. More specifically, when a second ID-added document is obtained by operating a first ID-added document, the first ID-added document is a parent of the second ID-added document, and the second ID-added document is a child of the first ID-added document. For example, when the document operation unit 200 performs an operation with respect to an ID-added document having a management ID “A” and a new ID-added document having a management ID “B” is obtained as a result of the operation, the management ID 312 in the meta information 310 of the latter document is “B” and the parent ID 314 of this document is “A.” Such a parent-child relationship will be referred to a “derivation relationship (of management IDs).”

Here, in a case where an operation of initially registering an electronic document which has not been registered in the present system is performed and also in a case where an operation of scanning or copying an unregistered paper document is performed (in the latter case, an ID-added document including an image obtained by reading the paper document as its document content is generated and registered in the present system), the ID-added document 300 which is generated would have no parent ID 314 (that is, no parent exists).

The log information 316 refers to information of various log items concerning the operation performed when the ID-added document is generated. The log items may include the time and date when the operation is performed, the type of the operation, a user (operator) who instructed the operation, and so on, and are not limited to these examples. The operation types include, for example, registration (i.e. registration of a new document in the present system), viewing, update (change of document content), printing, scanning, copying of a paper document, and so on. For example, when a user uses the document operation unit 200 to edit a first ID-added document and then instructs completion of editing, the log information 316 of the resulting second ID-added document may include the time of editing completion, identification information of a user who instructed the editing, and the type of operation “update.”

Here, the document operation unit 200 may encrypt a document which is obtained by an operation, in such a manner that a document operation unit 200 which conforms to the present system would be able to decrypt the encrypted document. In this case, the document content 320 of the ID-added document 300 output from the document operation unit 200, which has been encrypted, can be decrypted only by the document operation unit 200 conforming to the present system. Accordingly, when such an ID-added document is operated, in which case the document operation unit 200 is used, the operation is detected by the document operation unit 200 and the content of the operation is reported from the document operation unit 200 to the document management server 10. Further, in addition to the document content 320, the meta information 310 (or a portion of the meta information) which will be described below may also be encrypted.

Referring back to FIG. 2, the document operation unit 200 includes an ID assignment unit 202 and a derivation relationship incorporating unit 204 so as to generate the ID-added document 300 described above as a result of an operation. The ID assignment unit 202 assigns a unique management ID to an ID-added document generated as a result of an operation. The management ID needs to be identification information that is unique at least within the present system. For example, it is possible to obtain a hash value of an ID-added document 300 (excluding the management ID 312) to be generated as a result of an operation and use the hash value as a management ID of the ID-added document 300. When a collision-resistant cryptographic hash function, such as SHA-256 (which is a cryptographic hash function having a hash value of 256 bits defined in FIPS (Federal Information Processing Standards) 180-2 by NIST (National Institute of Standards and Technology), is used as the hash function, a management ID having practically sufficient uniqueness can be generated. As a matter of course, a method of generating a management ID which is unique within the system by each client terminal 20 is not limited to the above example. When the management ID includes identification information that is specific to each client terminal 20, the management ID that is unique within the system can be generated in each client terminal 20.

The derivation relationship incorporating unit 204 generates meta information 310 including a new management ID 312 assigned to a document obtained by a result of an operation performed by the ID assignment unit 202, a parent ID 314 which is a management ID of a parent document with regard to which the operation has been performed (in the case of initial registration, no such parent ID exists), and log information 316 concerning the operation. The derivation relationship incorporating unit 204 further adds the meta information 310 to the document content of the operation result to thereby generate and output an ID-added document 300 obtained after the operation.

The registration processing unit 210 performs processing for registering the ID-added document 300 output from the document operation unit 200 to the document management server 10. Thus, each client terminal 20 registers the ID-added document 300 obtained as a result of an operation performed by each client terminal 20 itself to the document management server 10 as described above, so that the document management server 10 can recognize the derivation relationships between the respective ID-added documents 300.

The ID-added document 300 output from the document operation unit 200 as a result of an operation can be sent to others by electronically copying or by attaching to an electronic mail and so on, similar to cases with general document files. When a user who receives an ID-added document 300 from another user uses the document operation unit 200 of his or her own client terminal 20 to operate the received ID-added document 300, a new ID-added document to which a new management ID is assigned in accordance with the operation is to be generated.

Further, during printing of an electronic document with the document operation unit 200, the document operation unit 200 may generate a management ID and embed the management ID in the printed electronic document. Here, embedding of the management ID can be performed, for example, by superposing a code image representing the management ID with a printed image of the electronic document. In this case, the document operation unit 200 registers an ID-added document including meta information such as the management ID, the operation type, which is “printing” in this case, and so on, in the document management server 10. Further, when an ID-added document is printed, a new ID-added document including the management ID of the ID-added document as a parent ID 314 is generated. The new ID-added document corresponding to such a printing operation may include, as the document content 320, printing data such as page description language data or bit map image data representing a printed image.

Further, when a paper document having a management ID embedded therein is read by the document operation unit 200, the document operation unit 200 assigns a new management ID with respect to the reading operation, and generates an ID-added document including an image of the reading result as the document content 320 and registers the ID-added document in the document management server 10. The management ID read from the original paper document is set as a parent ID 314 of the ID-added document. At the time of copying a paper document having a management ID embedded therein, both the reading processing and the printing processing described above are to be performed.

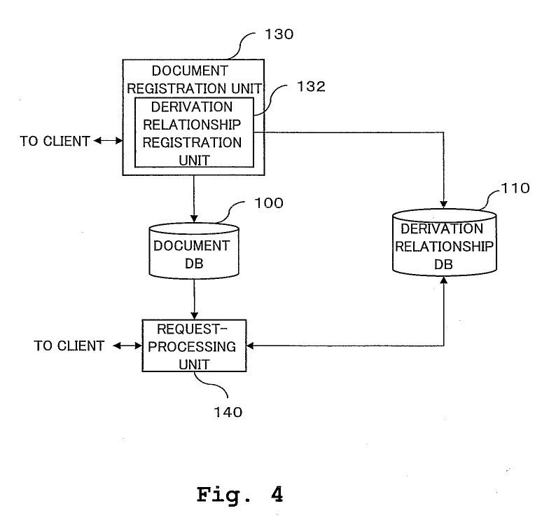

The document management server 10 will be described. The document management server 10 stores the ID-added documents 300 sent from multiple client terminals 20 in the system and on the basis of the stored information provides various services to users. As shown in FIG. 4, the document management server 10 includes a document DB 100, a derivation relationship DB 110, a document registration unit 130, and a request-processing unit 140.

The document DB 100 is a database that stores a document content 320 of an ID-added document 300 sent from the client terminal 20. Each document content 320 stored in the document DB 100 is managed by use of a unique content ID. Although a hash value obtained by a cryptographic hash function of the corresponding document content may be used as the content ID, the content ID is not limited to this example. The content ID may be assigned by the client terminal 20, in which case the content ID may be included in the meta information 310.

The document registration unit 130 registers the document content and the meta information of an ID-added document received from the client terminal 20 in the document DB 100 and the derivation relationship DB 110, respectively. Registration of the meta information, among the above information, is managed by a derivation relationship registration unit 132.

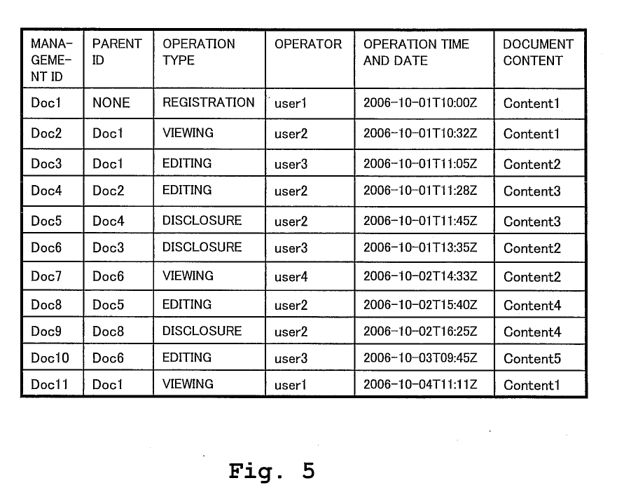

The derivation relationship DB 110 is a database that stores meta information mainly concerning the information of a derivation relationship in such an ID-added document 300. FIG. 5 shows an example data content of the derivation relationship DB 110. The information in one row in the table shown in FIG. 5 represents a meta information record corresponding to one ID-added document 300. In this example, items including a parent ID, an operation type, an operator, an operation time and date, and a document ID of the document content are registered in correspondence to the management ID of each ID-added document 300. The information items in the meta information record are not limited to the above example, and any items necessary for the purpose of management can be recorded, so long as the pair consisting of the management ID and the parent ID is included.

Here, FIG. 5 merely expresses the data managed by the derivation relationship DB 110 from a viewpoint of data content, and therefore does not specify any specific expression form or database form. For example, the derivation relationship DB 110 may be configured as a general relational database, or a database in which an XML (extensible Markup Language) document that describes meta information other than the management ID is registered while the management ID is used as a key.

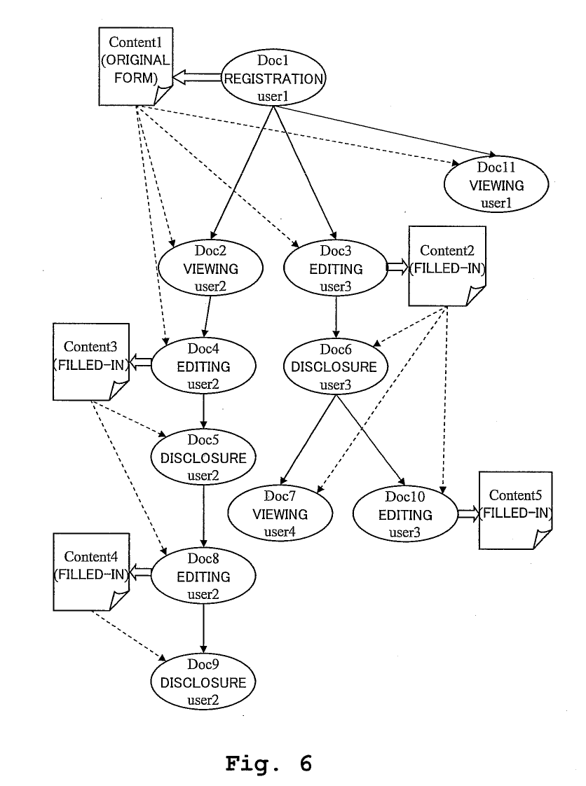

The data content of the derivation relationship DB 110 shown in FIG. 5 forms a tree structure as shown in FIG. 6, in which the management IDs are nodes and the parent-child relationships among the management IDs are edges.

The log of the documents shown in the example of FIGS. 5 and 6 will be described below in time sequence. In this example, there is shown an operation flow in which a certain user registers a form such as an application form in the present system and other users fill the form and register the filled-in form in the present system.

Specifically, in this example, a “registration” operation with respect to a document (form) is first performed by a client terminal of an operator “user1.” The “registration” operation is an operation for registering in the document management server 10 a document which has not been registered in the document management server 10 (i.e. a document having no management ID, which will also be referred to as an “unregistered document”). In accordance with this operation, an ID-added document including meta information having a management ID “Doc1,” no parent ID, and the operation type “registration” is sent from the client terminal to the document management server 10. The ID-added document also includes the document content of the document. In response, the document management server 10 registers the document content in the ID-added document “Doc1” in the document DB 100 and the meta information of the ID-added document “Doc1” in the derivation relationship DB 110. The document content which is registered is managed in association with the corresponding content ID “Content1.” Subsequently, the user1 distributes the ID-added document which is registered to other users “user2,” “user3,” . . . and so on. This distribution of the document can be performed by sending to each user an electronic mail to which the ID-added document is attached.

Thereafter, another user “user2” views the ID-added document “Doc1” by using the document operation unit 200 of his or her own client terminal. At this time, the user2 views the document content having the content ID “Content1.” The client terminal generates an ID-added document “Doc2” as a result of viewing and registers the ID-added document “Doc2” in the document management server 10. Here, because the document content is not changed or modified with the “viewing” operation, the content ID of the document content remains “Content1.” Here, when an operation by which the document content is not changed is performed as described above, the client terminal 20 may send to the document management server 10 an ID-added document having no document content. With this viewing operation, the ID-added document “Doc1” which was present within the client terminal 20 of the user2 before the operation is replaced with the ID-added document “Doc2” by the derivation relationship incorporating unit 204. More specifically, , with this replacing operation, the derivation relationship incorporating unit 204 changes the management ID 312 of the meta information 310 of the ID-added document “Doc1” to a new management ID “Doc2” and also sets the management ID “Doc1” of the document “Doc1” as a value of the parent ID 314 of the new document “Doc2.” In addition, the derivation relationship incorporating unit 204 changes the value of the operation type in the log information 316 to “viewing” which is the type of the current operation, changes the value of the operation time and date to those of the viewing operation, and also changes the value of the operator to “user2.” However, the document content 320 remains unchanged, because the current operation is “viewing.”

As described above, once having been viewed, the ID-added document “Doc1” is replaced with the ID-added document “Doc2” obtained after viewing. Accordingly, after this replacement, the ID-added document “Doc1” itself is no longer present within the client terminal 20 and the ID-added document “Doc2” is present in place of the ID-added document “Doc1.”

Then, another user “user3” edits the ID-added document “Doc1” by using the document operation unit 200 of his or her client terminal 20. In this case, when the user3 opens the ID-added document “Doc1” by means of the document operation unit 200, the document content “Content1” is presented, with regard to which the user3 performs an editing operation. Such an editing operation is performed when the user3 fills in the original form registered by the user1. When the user3 completes editing and closes the document, the document operation unit 200 generates an ID-added document “Doc3” as a result of editing, and registers the ID-added document “Doc3” in the document management server 10. The ID-added document “Doc3” includes meta information 310 including information items such as the management ID “Doc3,” the parent ID “Doc1,” the operation type “editing,” the operator “user3,” and so on, and the document content 320 obtained by the editing. Because the document content of the ID-added document “Doc3” has been changed or modified by the editing operation, the document content is associated with a new content ID “Content2” and then registered in the document DB 100.

Then, the user2 opens the ID-added document “Doc2” and performs an editing operation with respect to the document content “Content1” which is presented. When the editing is completed, the document operation unit 200 replaces the ID-added document “Doc2” with an ID-added document “Doc4” including the document content obtained as a result of the editing. The meta information 310 of the ID-added document “Doc4” includes the management ID “Doc4” and the parent ID “Doc2.” The document operation unit 200 then registers the ID-added document “Doc4,” which is an operation result, in the document management server 10. Because the document content included in the ID-added document “Doc4” has been changed or modified from the earlier version document content “Content1,” the new document content is registered in the document DB 100 in association with a new content ID “Content3.”

Thereafter, the user2 instructs the document operation unit 200 to perform a “disclosure” operation of the ID-added document “Doc4.” The “disclosure” operation is implemented, for example, as one of the procedures which can be executed with respect to an ID-added document. For example, by placing a cursor on the icon of an ID-added document on a screen displaying a list of folders or files in the folders and performing a predetermined operation such as right-clicking the icon by the user, “disclosure” is presented as one item of operation menu. Then, by selecting the item by the user, the “disclosure” operation is to be executed. This “disclosure” operation is an operation for recording the user's intention to disclose the document content (“Content3” in this example) of the subject ID-added document (“Doc4” in this example) to the operator (“user1” in this example) who instructed the “registration” operation of the ID-added document (“Doc1” in this example) which is the original (the initiator or root) of the subject ID-added document. More specifically, while, when the editing operation with regard to the management ID “Doc4” is completed, the user1 cannot yet obtain the document content “Content3” which is the editing result, the user1 can later obtain the document content “Content3” when the user2 performs the “disclosure” operation (“Doc5”). If the user2 temporarily terminates the editing operation in the middle of filling or when the user2 needs some time to determine whether or not to disclose the content, it is possible to inhibit the user1 from viewing the editing result at this stage unless the user2 performs the “disclosure” operation. The ID-added document “Doc5” which is registered in the document management server 10 as a result of the “disclosure” operation includes the parent ID “Doc4” and the operation type “disclosure.” When an ID-added document is requested by the user1, the document management server 10 can provide the ID-added document to the user1 only when the operation type with regard to the requested ID-added document is “disclosure.” Otherwise, the document management server 10 will not provide the requested document to the user1. Further, when receiving a request for retrieving an ID-added document from the user1, the document management server 10 provides to the user1 only ID-added documents associated with the operation type “disclosure” from among the ID-added documents matching the search condition.

Although in the above example the “disclosure” operation with regard to an ID-added document is an operation which allows the ID-added document to be disclosed only to an operator who registered the original of the ID-added document, the “disclosure” operation is not limited to this example and may be an operation which allows the subject ID-added document to be widely disclosed to general users of the present system.

Further, when the user3 instructs his or her own client terminal to perform a “disclosure” operation of the ID-added document “Doc3”, the client terminal generates an ID-added document “Doc6” including the management ID 312 “Doc6,” the parent ID 314 “Doc3,” and the operation type “disclosure,” and replaces the ID-added document “Doc3” with this ID-added document “Doc6” which is then registered in the document management server 10. Consequently, a record of the management ID “Doc6” is registered in the derivation relationship DB 110.

Thereafter, when the user3 sends the ID-added document “Doc6” to the user4 via an electronic mail and the like and the user4 views the ID-added document “Doc6” by means of his or her client terminal, the client terminal replaces the ID-added document “Doc6” with a new ID-added document “Doc7” in which the viewing operation has been reflected, and registers the ID-added document “Doc7” in the document management server 10.

Then, the user2 adds editing with respect to the ID-added document “Doc5.” For example, when correction with regard to the document content which was once filled and disclosed is necessary, the user2 performs editing with respect to such a disclosed ID-added document. Then, an ID-added document “Doc8” obtained as a result of the editing is registered in the document management server 10. Thereafter, when the user2 further instructs execution of a “disclosure” operation of the ID-added document “Doc8,” an ID-added document “Doc9” in which the “disclosure” operation has been reflected is registered in the document server 10.

Further, when the user3 performs editing with respect to the ID-added document “Doc6” which has been once disclosed, an ID-added document “Doc10” in which the editing has been reflected is registered in the document management server 10.

Thereafter, the user1 views the ID-added document “Doc1” (that is, the original form) present within his or her own client terminal for confirmation of the content. Consequently, the client terminal generates an ID-added document “Doc11” in which the viewing operation has been reflected and registers the ID-added document “Doc11” in the document management server 10. At this time, the ID-added document “Doc1” present within the client terminal is replaced with the ID-added document “Doc11.” FIGS. 5 and 6 show the documents derived from the document “Doc1” or the states of operations within the derivation relationship DB 110 at this time. At this time, the user3 has not performed a “disclosure” operation with respect to the ID-added document “Doc10.”

In the above description, with reference to the data content of the derivation relationship DB 110, for example, information registration concerning the document operations in the present system has been described.

Referring back to FIG. 4, in response to a service request including the management ID from the client terminal 20, the request-processing unit 140 provides a service using the derivation relationship DB 110. The service to be provided by the request-processing unit 140 may be a service for retrieving the latest version of a document (latest version document) corresponding to the management ID for which the service is being requested, for example. As a further service example, an initiator document (the original document) corresponding to the management ID for which the service is being requested or the log information concerning the initiator may be provided. As another service example, there may be provided the history of the management ID; i.e. the log of the operations experienced by the document from the initiator through that management ID (for example, an information list indicating by who and when and what type of operation is performed). Still another service example may be a service for collecting from the respective users the filled-in results with regard to the original form corresponding to the management ID.

The service request is issued on the basis of the ID-added document held in the client terminal 20. For example, when a user opens an ID-added document by the document operation unit 200 of the client terminal 20, the document operation unit 200 provides a menu listing services using the derivation relationship and accepts from the menu designation of a service desired by the user. The document operation unit 200 then sends to the request-processing unit 140 of the document management server 10 a service request including the management ID of the ID-added document and a code indicative of a designated service. Here, in addition to the management ID and the code indicative of a service, other information including identification information of a user who provides the instruction, authorization information input by the user, and so on may also be sent from the client terminal 20 to the request-processing unit 140.

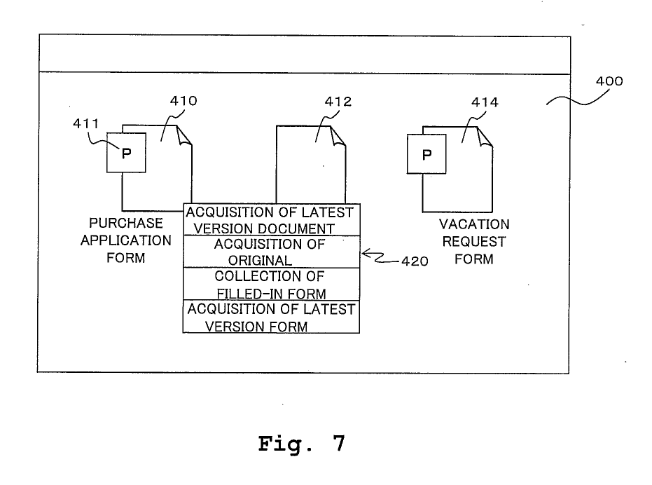

As another example, the service menu as described above may be associated with an object type; i.e. an ID-added document, and registered in the operating system of the client terminal 20. In this case, in response to a predetermined operation, such as right-clicking, which is performed by a user with respect to an icon 410 or 414 of an ID-added document displayed on a file management screen 400 provided by the operating system, the operating system displays a menu 420 corresponding to the ID-added document on the screen, as shown in FIG. 7. In the shown example, an ID-added document indicated by an icon 410 or 414 can be differentiated from a file of other types 412 by a mark 411 indicative of an ID-added document of the present system. When the user selects a desired service from the service items on the menu 420, the client terminal 20 requests the document management server 10 to perform the selected service item.

As a further example, it is conceivable to regard designation of a service by a user as one “operation” and assign a new management ID to the “operation.” In this case, an ID-added document including a code of a designated service as an operation type and the management ID of the ID-added document which is used at the time of designation as a parent ID may be generated and sent to the document management server 10 as a service request. In this case, on the basis of the information of the operation type included in the ID-added document thus received, the request-processing unit 140 determines a service to be provided and uses the parent ID similarly included in the ID-added document as a start point when tracing the derivation relationship.

Upon receiving a service request from the client terminal 20, the request-processing unit 140 traverses a tree formed by the derivation relationships of the management IDs and parent IDs registered in the derivation relationship DB 110, starting from the management ID designated during the service request, and executes a service requested by the user on the basis of the information obtained as a result of the traverse.

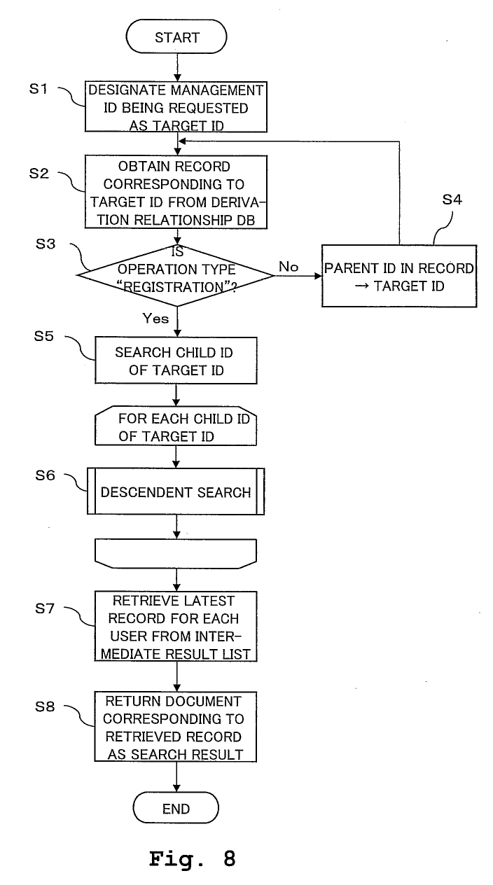

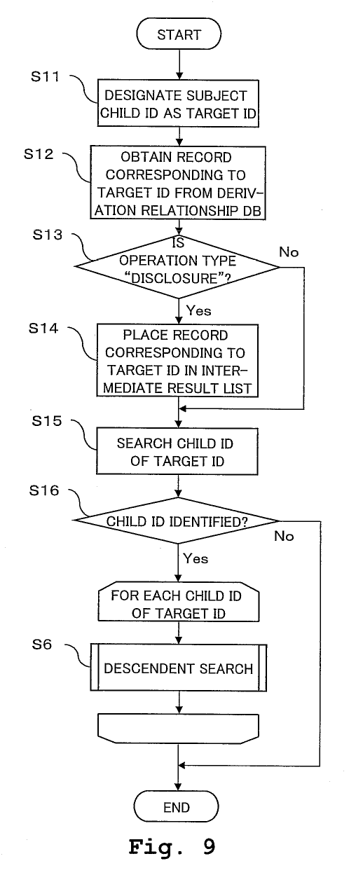

With reference to FIGS. 8 and 9, there will be described the processing procedure performed by the request-processing unit 140 when “collection of filled-in forms” is requested as one example of a service request. In the specific example which will be described below, it is assumed that, with the data content of the derivation relationship DB 110 as illustrated in FIGS. 5 and 6, the user1 has made a request for “collection of filled-in forms” with regard to the ID-added document “Doc11” within his or her own client terminal 20.

In this procedure, the request-processing unit 140 extracts the management ID included as a processing subject from the request, “collection of filled-in forms,” received from the client terminal 20, and sets the management ID as a target ID (S1). The request-processing unit 140 then obtains a record corresponding to the target ID from the derivation relationship DB 110 (S2). Here, a record corresponding to the target ID refers to a record including the target ID as a value of the item “management ID” in the record. The request-processing unit 140 then checks whether or not the value of the item of the operation type in the record which is obtained is “registration” (S3), and if the value is not “registration,” the value of the target ID is replaced with the value of the parent ID in the record (S4), and repeats the steps S2 and S3. This loop of steps S2 to S4 represents processing in which the tree structure of the derivation relationship is traced from the management ID for which the service is being requested, to thereby search for the “registration” operation of the original form which is the origin (root). When the determination result in step S3 is Yes, the target ID at this time corresponds to the “registration” operation which is the “root.” In the example shown in FIG. 5, by tracing the tree structure from the management ID “Doc11,” the management ID “Doc1” which is the root can be ultimately reached.

When the “registration” operation, which is the root, is reached, the request-processing unit 140 searches for a child ID of the target ID (root) at this time (S5). Specifically, the child ID of the target ID corresponds to a “management ID” in a record which includes the target ID as a value of the “parent ID” in the derivation relationship DB 110. Once all the child IDs of the target ID are identified, the request-processing unit 140 performs descendent search processing as shown in FIG. 9 with regard to each of these child IDs (S6).

In the descendent search processing (S6), the request-processing unit 140 designates the child ID as a target ID (S11) and obtains a record corresponding to the target ID from the derivation relationship DB 110 (S12). The request-processing unit 140 then determines whether or not the value of the operation type in the record is “disclosure” (S13), and if the value is “disclosure,” places the record in an intermediate result list (S14). Here, the intermediate result list is a list created on a storage device of the client terminal 20 for storing information which can be used as materials for obtaining a result of the processing which is requested. If the operation type is not “disclosure” in step S13, the processing in step 14 is to be skipped. The request-processing unit 140 then searches for a child ID of the target ID (S15), and a determination is made as to whether or not a child ID has been identified (S16). If the child IDs are identified, the request-processing section 140 recursively executes the descendent search processing for each of the child IDs (S6). When the descendent search processing is completed for all the child IDs, the processing with regard to the subject target ID is to be completed. Even if no child IDs are identified in step S16, the processing with regard to the subject target ID is to be completed.

Referring back to the procedure shown in FIG. 8, when the descendent search processing (S6) is completed for all the child IDs of the root ID-added document, the intermediate result list at this time has stored all the records corresponding to the ID documents including the operation type “disclosure” among all the ID-added documents derived from the root ID-document. The request-processing unit 140 then sorts through the records stored in the intermediate list, on the basis of the values of the operation time and date and the operators, for example, to thereby obtain the latest record for each operator among these records (S7). The request-processing unit 140 further provides to the user1 who issued the request, as a search result in response to the request, an ID-added document corresponding to the latest record which is obtained for each operator (S8). Here, it may be the case that an ID-added document for which the operator is the user1 who issued the request is not provided as the search result.

In the example shown in FIG. 6, for example, with the processing in step 6, three records having the management IDs “Doc5,” “Doc6,” and “Doc9,” respectively, are stored in the intermediate result list. Among them, the record with the management ID “Doc9” is the latest record for the user2, and the record with the management ID “Doc6” is the latest record for the user3, and these records are to be provided to the user1 who issued the request as a search result.

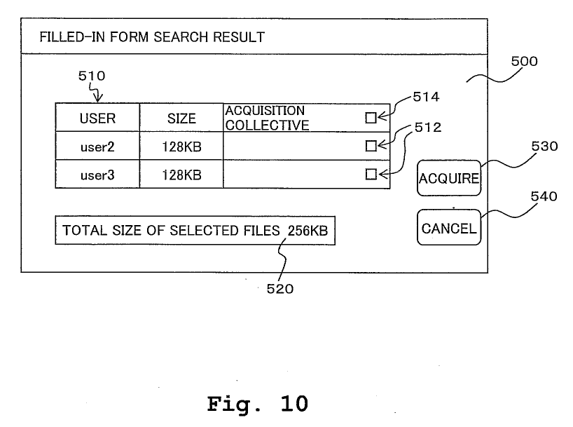

FIG. 10 shows an example of a search result display screen 500 provided by the document management server 10 to the user1 who issued the request. In this example, a list of search results shows an operator of each retrieved record, the size of document content corresponding to each record, and a check box 512 indicating whether or not it is necessary to acquire each record. Further, in this example, a check box 514 indicating collective acquisition of all the records in the list 510 is also provided. Although in the example shown in FIG. 10 the operators and document content sizes are displayed, any other items included in the record may be displayed in the list 510. This search result display screen 500 can be provided as a Web page, for example.

The user (user1 in this example) selects a record (which corresponds to an ID-added document) which the user wishes to acquire among the records shown in the list 510, by checking the corresponding check box 512. The box 520 then displays a total size of the records selected as the subjects of acquisition from the list 510. When the user depresses an acquisition button 530, the client terminal 20 sends an acquisition request including the management IDs of the selected records to the request-processing section 140 of the document management server 10. On the other hand, when the user depresses a cancel button 540, the client terminal 20 closes the screen 500 without issuing an acquisition request. Further, there may be provided a user interface screen for designating a location where a document selected as the acquisition subject is to be stored and/or a file name of the stored document. In this case, the ID-added document provided from the document management server 10 in response to the acquisition request is to be stored in accordance with the designation indicated on the screen.

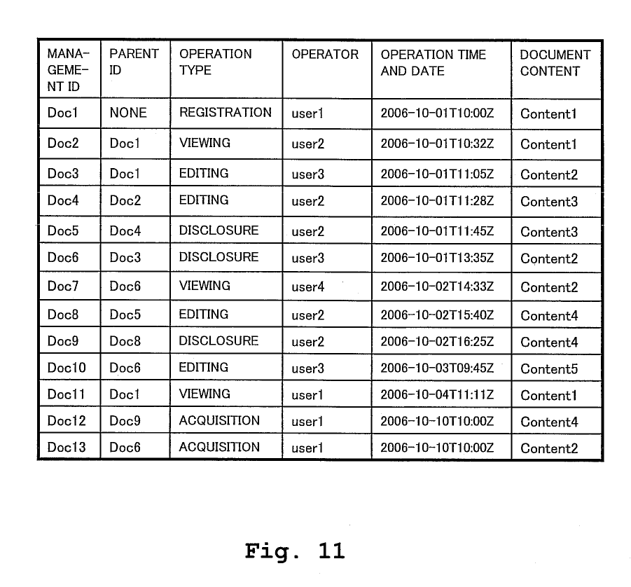

Upon receiving the acquisition request from the client terminal 20, the request-processing unit 140 searches the derivation relationship DB 110 for a record corresponding to each management ID included in the request and further searches the document DB 100 for the document content corresponding to each record which is retrieved. The request-processing unit 140 then generates, for each document content which is retrieved, a new ID-added document including the document content, and provides the ID-added document to the client terminal of the user who issued the request. The new ID-added document includes a management ID newly assigned by the document management server 10 and also the management ID included in the acquisition request as the value of the parent ID. Further, with regard to the new ID-added document, the operation type is “acquisition,” and the operator is a user who issued the request, and the operation time and date are those when the new ID-added document was generated. For example, in a state illustrated in FIG. 5, when the user1 acquires the filled-in form “Doc9” of the user2 and the filled-in form “Doc6” of the user3, the data contents of the derivation relationship DB 110 will be those shown in FIG. 11, for example. Specifically, in the example shown in FIG. 11, new documents having the management IDs “Doc12” and “Doc13” are added to the data contents shown in FIG. 5.

It should be noted that the processing performed by the request-processing unit 140 in response to the acquisition request is not limited to the above example. As an alternative, the request-processing unit 140 may obtain an ID-added document including the meta information record and the document content corresponding to the management ID included in the acquisition request from the derivation relationship DB 110 and the document DB 100, and return the thus-obtained ID-added document to the client terminal. In this example, the request-processing unit 140, in response to an acquisition request including the management ID “Doc6,” returns the ID-added document “Doc6” to a requesting user. The client terminal 20, upon receiving the ID-added document in response to the acquisition request, generates a new management ID based on the management ID of the ID-added document and overwrites the management ID of the ID-added document with the new value. The client terminal 20 also overwrites the parent ID with the management ID of the ID-added document. Further, the client terminal 20 changes the value of the operation type in the ID-added document to “acquisition,” changes the operator to the user1 who issued the acquisition request, and also changes the operation time and date. Then, the client terminal 20 stores the ID-added document which has been changed as described above in the designated storage location and also registers the ID-added document in the document management server 10.

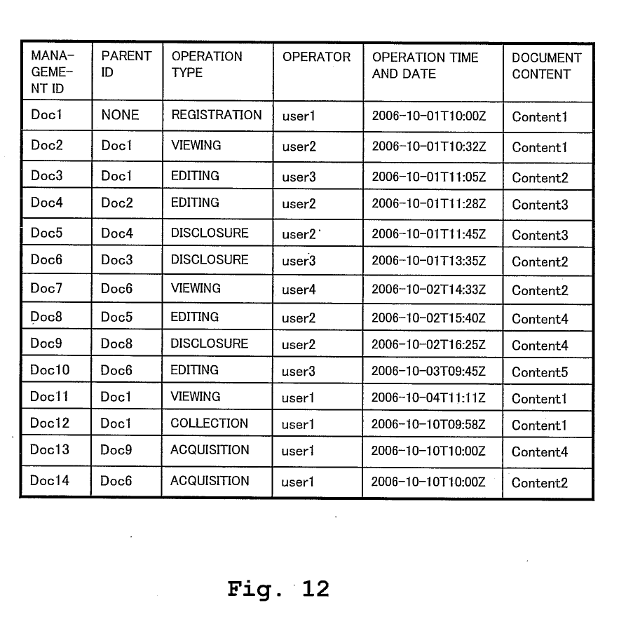

Here, when the client terminal 20 sends a service request in the form of an ID-added document to the document management server 10, the ID-added document is also registered in the document management server 10. For example, in the example described above, as illustrated in FIG. 12, in addition to the record “Doc12” corresponding to the operation of “collection of filled-in forms,” the records “Doc13” and “Doc14” corresponding to the filled-in forms actually acquired by the requesting user are registered.

Further, in order to authorize only a user who registered the original form to execute “collection of filled-in forms,” the request processing unit 140 may execute user authentication. For example, when the client terminal 20 issues a service request, identification information of a user who instructed execution of that service may be included in the service request. In this case, upon receiving the service request, the request-processing unit 14 traces the tree structure of the derivation relationships starting from the management ID included in the request to find an operator of the root record. If the operator which is found matches the identification information of the requesting user, the request-processing unit 14 may determine that the service request was issued from an authorized user. When a service request is sent to the request-processing unit 140 in the form of an ID-added document, the identification information of a user who instructed execution of the service is included in the ID-added document. Here, in addition to the user identification information included in the ID-added document, the user is caused to input further authentication information such as passwords or the like, and user authentication may be performed on the basis of the authentication information.

A modified example will be described below. In this modified example, in consideration of the possibility that the original form is to be updated, a structure which allows a user to acquire the latest version corresponding to the ID-added document owned by the user will be provided.

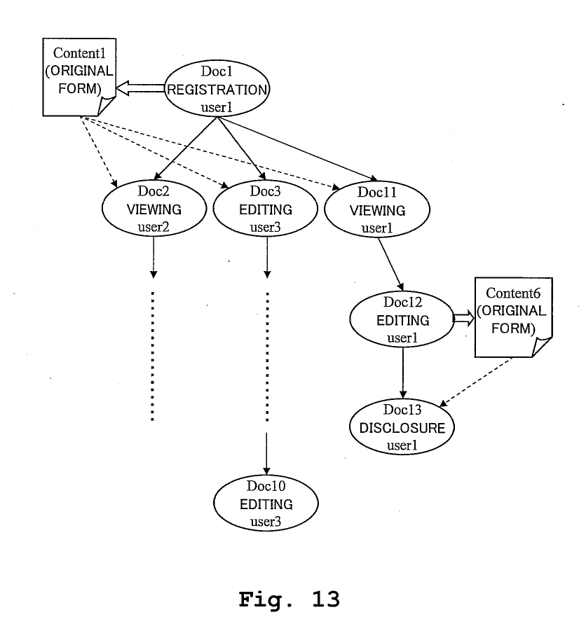

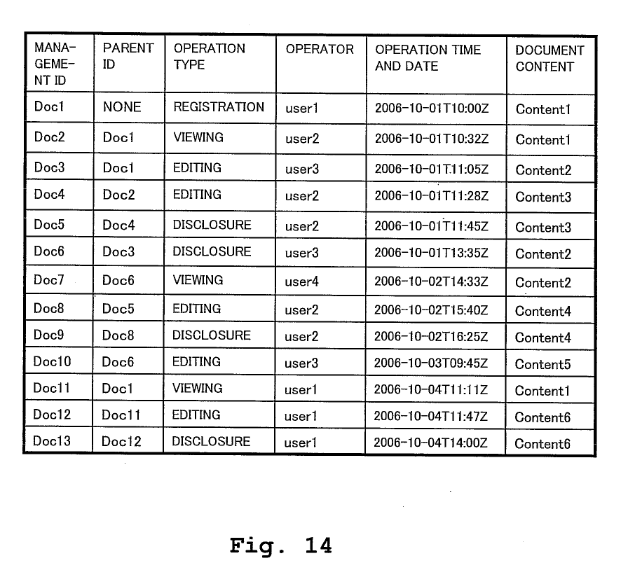

It is assumed, for example, that, in a state shown in FIGS. 5 and 6, the user1 opens the ID-added document “Doc11” and edits the document, and further performs a “disclosure” operation with respect to the edited result. The tree structure of the ID-added documents and the corresponding data contents of the derivation relationship DB 110 are shown in FIGS. 13 and 14, respectively. In FIG. 13, in order not to make the drawings complicated, the subtree following “Doc2” and the subtree following “Doc3” are omitted. As shown in these figures, with the series of operations described above, the ID-added document “Doc11” in the client terminal 20 of the user1 first changes to the ID-added document “Doc12.” and then further changes to the ID-added document “Doc13.” In the course of this processing, the document content of the edited result is registered in the document DB 100 in association with the content ID “Content6.” The operation type of the ID-added document “Doc13” is “disclosure,” which is also registered in the derivation relationship DB 110. It is then assumed that in the state shown in FIGS. 13 and 14, the user3 issues an “acquisition of the latest version form” request with regard to the ID-added document “Doc10” via the user interface screen illustrated in FIG. 7, for example. An example processing procedure performed by the request-processing unit 140 when receiving the request for “acquisition of the latest version form” under the above state will be described.

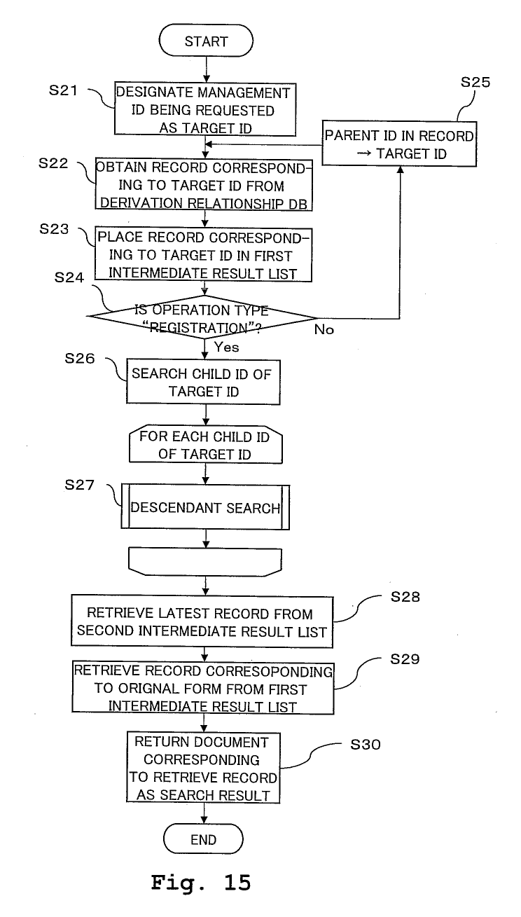

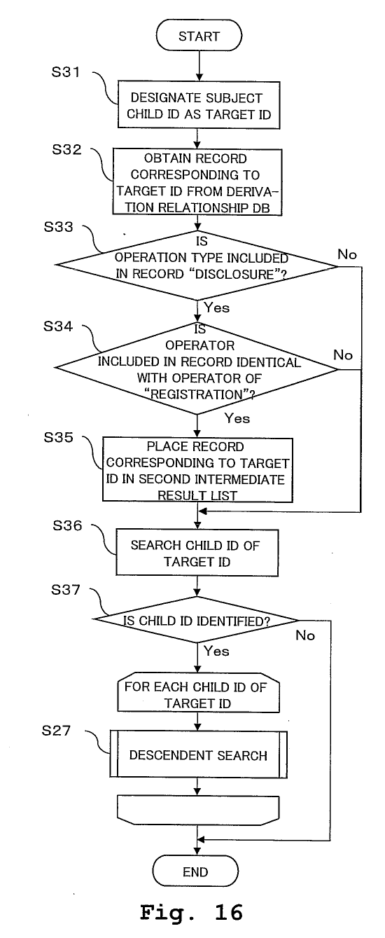

In this case, the request-processing section 140 obtains the latest version form in accordance with the procedure shown in FIGS. 15 and 16, for example. In the procedure shown in FIG. 15, the request-processing unit 140 first sets the management ID included as the processing subject in the request received from the client terminal 20 to a target ID (S21), and then acquires a record corresponding to the target ID from the derivation relationship DB 110 (S22). The request-processing unit 140 further places the record corresponding to the target ID in a first intermediate list (S23). Then, the request-processing unit 140 checks whether or not the value of the item of the operation type in the record is “registration” (S24), and if the value is not “registration,” replaces the value of the target ID with that of the parent ID in the record (S25), and repeats steps S22 to S25. With the loop of steps S22 to 25, all the records that are present in the path of the tree structure from the management ID included in the acquisition request to the root of the tree (i.e. a record corresponding to the “registration” operation) are stored in the first intermediate list.

If the determination result in step S24 is Yes, the request-processing unit 140 searches for child IDs of the target ID at this time (i.e. the root of the tree structure) (S26), and executes the descendent search processing as shown in FIG. 16 for each child ID (S27).

In the descendent search processing (S27), the request-processing unit 140 designates the child ID corresponding to the target ID (S31), and acquires a record corresponding to the target ID from the derivation relationship DB 110 (S32). The request-processing unit 140 then determines whether or not the value of the operation type in the record is “disclosure” (S33), and also determines whether or not the value of the operator in the record is identical with the operator who executed the “registration” operation specified by the loop of the steps S22 to 25 (S34). Here, either the step S33 or the step S34 may be performed first. If the determination results in both steps S33 and S34 are Yes, the request-processing unit 140 places the record in a second intermediate result list (S35). On the other hand, if at least one of the determination results in steps S33 and S34 is No, the processing in step S35 is skipped. The request-processing unit 140 then searches for a child ID of the target ID (S36) and determines whether or not any child IDs are identified (S37). If any child IDs are identified, the request-processing unit 140 recursively executes the descendent search processing (S27) concerning each child ID. When the descendent search processing is completed for all the child IDs or when no child IDs are identified in step S37, the processing concerning the target ID is completed.

Referring back to the procedure shown in FIG. 15, when the descendent search processing (S27) is completed with regard to all the child IDs of the root ID-added document, all the ID-added documents which are disclosed by the operator of the “registration” operation have been stored in the second intermediate result list. Here, the ID-added documents disclosed by the operator of the “registration” operation are the original form or the update version thereof. The request-processing unit 140 obtains the latest record from among the records stored in the intermediate result list (S28). The ID-added document corresponding to the latest record thus obtained is the latest version of the form.

Further, the request-processing unit 140 extracts, from among the records stored in the first intermediate result list, a record in which the value of the operator is the same as that of the operator of the “registration” operation and simultaneously the value of the operation type is “registration” or “disclosure,” and further obtains the latest record from among the records thus extracted (S29). The latest record obtained in step S29 corresponds to a form which is not yet filled in (referred to as the original form) and also which is a source of an ID-added document designated by the user who issued the acquisition request as the subject of the request (i.e. the ID-added document “Doc10” in this example).

The request-processing unit 140 provides the latest version form obtained in step S28 and the original form obtained in step S29 to the requesting source (which is the user3 in this example) as a search result in response to the request (S30).

In the example shown in FIG. 13, for example, with the processing in step S27, two records having the management IDs “Doc1” and “Doc13” are stored in the second intermediate result list, and, of these records, the ID-added document “Doc13” corresponding to the latest record is obtained in step S28. Further, in step S29, among the records “Doc10,” “Doc6,” “Doc3,” and “Doc1” stored in the first intermediate result list (see also FIG. 6), the ID-added document “Doc1” which satisfied the above conditions is obtained.

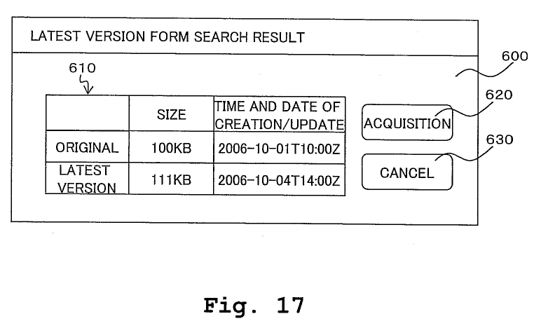

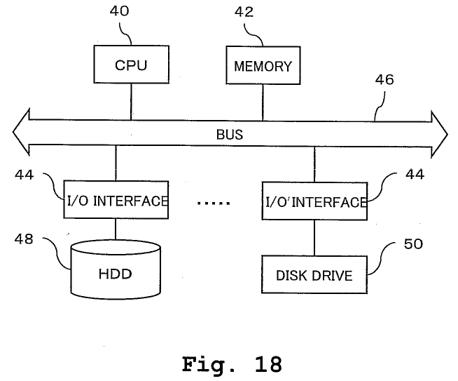

FIG. 17 shows an example search result display screen 600 to be provided to the user3 who issued the request by the document management server 10 on the basis of the processing described above. In this example, a search result list 610 indicates, with regard to each of the original form and the latest version form which are retrieved, the size and the time and date of creation or update (i.e. the “operation time”). Here, in addition to the size and the time and date of the files, any other items included in the record may be included in the list 610. The user sees this display to determine whether or not to acquire the latest version form. The user, upon determining to acquire the latest version form, depresses an acquisition button 620. In response, the client terminal 20 sends an acquisition request including the management ID corresponding to the latest version form to the request-processing unit 140 of the document management server 10. If the user presses a cancel button 630, the client terminal 20 closes this screen 600 without issuing an acquisition request.

Upon receiving the acquisition request for the latest version form from the client terminal 20, the request-processing unit 140 searches the derivation relationship DB 110 for a record corresponding to the management ID included in the request, and provides the ID-added document (i.e. the latest version form) including the retrieved record and the corresponding document content to the client terminal 20 of the user who issued the request. The client terminal 20 then generates a new management ID based on the management ID included in the ID-added document which is received and overwrites the management ID in the ID-added document with the new value. The client terminal 20 further overwrites the parent ID in the ID-added document with the management ID of the ID-added document. In addition, the client terminal 20 changes the value of the operation type in the ID-added document to “acquisition,” changes the operator to user3 who issued the acquisition request, and also changes the operation time. The client terminal 20 then stores the ID-added document thus changed, and also registers the ID-added document in the document management server 10.

Although in the exemplary embodiment and the modified example described above the management ID is issued by each client terminal 20, the document management server 10 may instead issue the management ID. In this case, the client terminal 20, when performing an operation with respect to an ID-added document, generates document data which include the management ID in the ID-added document prior to the operation as the parent ID 34, the log information 316 concerning the operation, and the document content 320 obtained after the operation, with no management ID 312, and sends the document data to the document management server 10. The document management server 10 then assigns a new management ID to the document data which is received and registers the management ID and the information included in the document data in the document DB 100 and the derivation relationship DB 110. The document management server 10 further sets the assigned management ID in the document data to generate an ID-added document, and returns this ID-added document to the client terminal 20. The client terminal 20 then replaces the ID-added document prior to the operation with the ID-added document which is received. As such, the processing of the exemplary embodiment and the modified example can be executed similarly with the structure in which the management ID is assigned by the document management server 10.

Further, although in the exemplary embodiment and modified example described above, the ID-added document 300 including the management ID 312, the parent ID 314, the log information 316, and the document content 329 is stored in the client terminal 20, there may be employed a configuration where only the management ID is stored in the client terminal 20 while other information is stored in the document management server 10. In this case, when the client terminal 20 is to perform operation with regard to a document, the management ID corresponding to the document is sent to the document management server 10, which then provides the corresponding document to the client terminal 20.

Here, when the document management server 10 assigns the management ID, the document management server 10 generates a management ID corresponding to the acquisition operation and provides the management ID in association with the document to the client terminal 20. The document management server 10 also records in the derivation relationship DB 110 the log information (the operation time and date, the operator, and so on) concerning the acquisition operation, the earlier management ID (i.e. the parent ID), and the assigned management ID. The client terminal 20 replaces the management ID sent to the document management server 10 with the management ID which is received, and opens the received document. The user then performs an operation such as viewing and editing with respect to the opened document. When the operation with respect to the document is completed, the client terminal 20 sends the document obtained by the operation, along with the management ID and the log information concerning the operation, to the document management server 10. The document management server 10 assigns a new management ID to the document which is received and registers the document with the new management ID in the derivation relationship DB 110, and further registers the management ID which is received from the client terminal 20 in the derivation relationship DB 110 as the parent ID. In addition, the document management server 10 registers the log information and the document after the operation which is received in the derivation relationship DB 110 and the document DB 100, respectively. The document management server 10 then returns to the client terminal 20 the management ID newly assigned. The client terminal 20 replaces the earlier management ID with the received management ID. With the above processing, the derivation relationships among the operations are to be accumulated in the document management server 10.

Meanwhile, in the structure in which the management ID is assigned by the client terminal 20, the document management server 10 can return to the client a document corresponding to the management ID received from the client terminal 20. The client terminal 20 opens the document which is received, so that the user can perform operation on the document. After completion of the operation, the client terminal 20 assigns a new management ID to the document obtained as a result of the operation and sends to the document management server 10 the ID-added document described above including this new management ID and the corresponding information. Then, the client terminal 20 stores only the management ID in the ID-added document and deletes other information.

Although in the above examples a form (template) document is described, the exemplary embodiments described above may be similarly applicable to cases of collecting the operation results of users with respect to any document other than the form document.

The document management server 10 in the illustrated system described above is typically implemented by executing a program that describes the function or processing contents of each unit of the document management server described above, by means of a general-purpose computer. As shown in FIG. 18, the computer includes, as hardware, a circuit structure in which a CPU (central processing unit) 40, a memory (primary memory) 42, various I/O (input/output) interfaces 44, and so on are interconnected via a bus 46, for example. Further, a hard disk drive 48 and a disk drive 50 for reading a portable non-volatile recording medium of various standards such as CDs and DVDs and flash memories are connected, via the I/O interfaces 44, for example, to the bus 46. Such a drive 48 or 50 functions as an external storage device for the memory. The program that describes the processing contents of the exemplary embodiment is stored in a fixed storage device such as the hard disk drive 48 via a recording medium such as a CD or DVD or via the network, and then installed in the computer. When the program stored in the fixed storage device is read into the memory and performed by the CPU, the processing of the exemplary embodiment is implemented. Similarly, the client terminal 20 can be implemented by causing a general-purpose computer to perform a program that describes the document-processing program described above.

The foregoing description of the exemplary embodiments of the present invention has been provided for the purposes of the illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A second information-processing apparatus, comprising:
a registration unit that receives log information including information concerning an operator that performed an operation with respect to a first document, time and date of the operation, and a second document obtained as a result of the operation, from a first information-processing apparatus and registers the log information in a storage unit, the registration unit, when the first document is already registered in the storage unit, further registering a derivation relationship indicating that the first document is a parent of the second document in the storage unit; and
a document-providing unit that, in response to a collection instruction including information that specifies a subject document, specifies and provides a latest version document with regard to each operator from documents included in a tree to which the subject document belongs among trees formed by derivation relationships stored in the storage unit, on the basis of the log information.

2. The second information-processing apparatus according to claim 1, wherein
the registration unit registers in the storage unit the log information further including information concerning a type of the operation, and
the document-providing unit specifies, for each type of the operation in corresponding log information, the latest version document with regard to each operator from among documents included in a tree to which the subject document belongs.

3. The second information-processing apparatus according to claim 1, wherein
the registration unit registers in the storage unit the log information further including information concerning a type of the operation, and
the document-providing unit specifies the latest version document with regard to each operator from documents having corresponding log information including a disclosure operation as the type of the operation, among documents included in a tree to which the subject document belongs.

4. The second information-processing apparatus according to claim 1, further comprising:
a latest version original providing unit that, in response to an instruction for acquiring a latest version original including information that specifies a subject document, specifies and provides a latest version document having corresponding log information in which an operator is the same as an operator in log information corresponding to a root document of a tree to which the subject document belongs, from among trees formed by derivation relationships stored in the storage unit, on the basis of the log information.

5. A computer-readable medium storing a program causing a computer to execute a process for document provision, the program causing the computer to function as:
a registration unit that receives log information including information concerning an operator that performed an operation with respect to a first document, time and date of the operation, and a second document obtained as a result of the operation, from a first information-processing apparatus, and registers the log information in a storage unit, the registration unit, when the first document is already registered in the storage unit, further registering in the storage unit a derivation relationship indicating that the first document is a parent of the second document; and
a document-providing unit that, in response to a collection instruction including information that specifies a subject document, specifies and provides a latest version document with regard to each operator from documents included in a tree to which the subject document belongs among trees formed by derivation relationships stored in the storage unit, on the basis of the log information.

6. The computer-readable medium according to claim 5, wherein
the registration unit registers in the storage unit the log information further including information concerning a type of the operation, and
the document-providing unit specifies, for each type of the operation in corresponding log information, the latest version document with regard to each operator from among documents included in a tree to which the subject document belongs.

7. The computer-readable medium according to claim 5, wherein
the registration unit registers in the storage unit the log information further including information concerning a type of the operation, and
the document-providing unit specifies the latest version document with regard to each operator from documents having corresponding log information including a disclosure operation as the type of the operation, among documents included in a tree to which the subject document belongs.

8. The computer-readable medium according to claim 5, wherein the program causes the computer to further function as:
a latest version original providing unit that, in response to an instruction for acquiring a latest version original including information that specifies a subject document, specifies and provides a latest version document having corresponding log information in which an operator is the same as an operator in log information corresponding to a root document of a tree to which the subject document belongs, from among trees formed by derivation relationships stored in the storage unit, on the basis of the log information.

9. An information-processing system comprising a first information-processing apparatus and a second information-processing apparatus,
the first information-processing apparatus including a sending unit that sends log information including information concerning an operator that performed an operation with respect to a first document, time and date of the operation, and a second document obtained as a result of the operation; and
the second information-processing apparatus including a registration unit that receives the log information from the first information-processing apparatus and registers the log information in a storage unit, the registration unit, when the first document is already registered in the storage unit, further registering in the storage unit a derivation relationship indicating that the first document is a parent of the second document, and a document-providing unit that, in response to a collection instruction including information that specifies a subject document, specifies and provides a latest version document with regard to each operator from documents included in a tree to which the subject document belongs among trees formed by derivation relationships stored in the storage unit, on the basis of the log information.

10. The information-processing system according to claim 9, wherein
the registration unit registers in the storage unit the log information further including information concerning a type of the operation, and
the document-providing unit specifies, for each type of the operation in corresponding log information, the latest version document with regard to each operator from among documents included in a tree to which the subject document belongs.

11. The information-processing system according to claim 9, wherein
the registration unit registers in the storage unit the log information further including information concerning a type of the operation, and
the document-providing unit specifies the latest version document with regard to each operator from documents having corresponding log information including a disclosure operation as the type of the operation, among documents included in a tree to which the subject document belongs.

12. The information-processing system according to claim 9, wherein the second information-processing apparatus further including:
a latest version original providing unit that, in response to an instruction for acquiring a latest version original including information that specifies a subject document, specifies and provides a latest version document having corresponding log information in which an operator is the same as an operator in log information corresponding to a root document of a tree to which the subject document belongs, from among trees formed by derivation relationships stored in the storage unit, on the basis of the log information.

13. A method for document provision, comprising:
receiving log information including information concerning an operator that performed an operation with respect to a first document, time and date of the operation, and a second document obtained as a result of the operation, from a first information-processing apparatus;
registering the log information in a storage unit;
when the first document is already registered in the storage unit, further registering a derivation relationship indicating that the first document is a parent of the second document in the storage unit; and
in response to a collection instruction including information that specifies a subject document, specifying and providing a latest version document with regard to each operator from documents included in a tree to which the subject document belongs among trees formed by derivation relationships stored in the storage unit, on the basis of the log information.

14. The method according to claim 13, wherein
the registering the log information in the storage unit includes registering in the storage unit the log information further including information concerning a type of the operation, and
the specifying and providing the latest version document includes specifying, for each type of the operation in corresponding log information, the latest version document with regard to each operator from among documents included in a tree to which the subject document belongs.

15. The method according to claim 13, wherein
the registering the log information in the storage unit includes registering in the storage unit the log information further including information concerning a type of the operation, and
the specifying and providing the latest version document includes specifying the latest version document with regard to each operator from documents having corresponding log information including a disclosure operation as the type of the operation, among documents included in a tree to which the subject document belongs.

16. The method according to claim 13, further comprising:
in response to an instruction for acquiring a latest version original including information that specifies a subject document, specifying and providing a latest version document having corresponding log information in which an operator is the same as an operator in log information corresponding to a root document of a tree to which the subject document belongs, from among trees formed by derivation relationships stored in the storage unit, on the basis of the log information.

17. A computer data signal embodied in a carrier wave for enabling a computer to perform a process for document provision, the computer data signal causing the computer to function as:
a registration unit that receives log information including information concerning an operator that performed an operation with respect to a first document, time and date of the operation, and a second document obtained as a result of the operation, from a first information-processing apparatus, and registers the log information in a storage unit, the registration unit, when the first document is already registered in the storage unit, further registering in the storage unit a derivation relationship indicating that the first document is a parent of the second document; and
a document-providing unit that, in response to a collection instruction including information that specifies a subject document, specifies and provides a latest version document with regard to each operator from documents included in a tree to which the subject document belongs among trees formed by derivation relationships stored in the storage unit, on the basis of the log information.

18. The computer data signal according to claim 17, wherein
the registration unit registers in the storage unit the log information further including information concerning a type of the operation, and
the document-providing unit specifies, for each type of the operation in corresponding log information, the latest version document with regard to each operator from among documents included in a tree to which the subject document belongs.

19. The computer data signal according to claim 17, wherein
the registration unit registers in the storage unit the log information further including information concerning a type of the operation, and
the document-providing unit specifies the latest version document with regard to each operator from documents having corresponding log information including a disclosure operation as the type of the operation, among documents included in a tree to which the subject document belongs.

20. The computer data signal according to claim 17, wherein the computer data signal causes the computer to further function as:
a latest version original providing unit that, in response to an instruction for acquiring a latest version original including information that specifies a subject document, specifies and provides a latest version document having corresponding log information in which an operator is the same as an operator in log information corresponding to a root document of a tree to which the subject document belongs, from among trees formed by derivation relationships stored in the storage unit, on the basis of the log information.
